(19) United States
(12) Patent Application Publication
(10) Pub. No.: US 2020/0232501 A1
(43) Pub. Date: Jul. 23, 2020

(54) SUCTION FOOT

(71) Applicant: BREVILLE PTY LIMITED, Alexandria, New South Wales (AU)

(72) Inventors: Stephen John McClean, Camden South, New South Wales (AU); Pierce James Barnard, Cherrybrook, New South Wales (AU); Margaret Antkowiak, Bronte, New South Wales (AU)

(73) Assignee: BREVILLE PTY LIMITED, Alexandria, New South Wales (AU)

(21) Appl. No.: 15/761,411

(22) PCT Filed: Sep. 29, 2016
(86) PCT No.: PCT/AU2016/050913

§ 371 Date: Mar. 19, 2018

(30) Foreign Application Priority Data
Sep. 29, 2015 (AU) 2015903964
Dec. 17, 2015 (AU) 2015905240

(51) Int. Cl. F16B 47/00; A47G 29/087

(52) U.S. Cl. CPC F16B 47/006; A47J 45/02; A47G 29/087

(57) ABSTRACT

A suction foot for a device or appliance has a side wall in which is formed a notch. The notch begins at a lower most rim of the foot.

### FIELD OF THE INVENTION

The invention relates to suctions cups and more particularly to a suction cup style foot that can be used with home appliance and other devices.

### BACKGROUND OF THE INVENTION

Suctions cups are incorporated into supporting feet in a wide range of applications. On a smooth enough surface, the suction cup creates a partial vacuum within itself that resists dislodgement from the surface on which it is resting. By adhering the device or appliance to the rest surface in this way, the device resists being displaced. This is a useful outcome where the device has a tendency to move or vibrate, for example, when the device incorporates an electric motor.

However, the same vacuum or suction forces that adhere the device to a rest surface also make the device more difficult to dislodge from that surface or move on that surface. In effect, the device can only be dislodged or moved once the peripheral seal associated with the suction cup foot is interrupted. When the foot seal is interrupted, air flows into the interior of the suction cup whereupon it behaves more like a conventional rubber foot.

In some circumstances, such as when the sealing rim of a suction cup type foot is large enough, it can be difficult to interrupt the seal by pulling vertically upward on the appliance that it supports. Some suction cups have pull tabs on the peripheral rim which makes interrupting the seal easier than simply pulling the suction cup off the rest surface by sheer force. However, in many devices, such as countertop appliances, the number of feet are more than one. Because one or both hands are required to some devices, using pull tabs is not an effective solution and therefore pull tabs are less practical on a device having two or more suction feet.

### OBJECTS AND SUMMARY

It is an object of the invention to provide a suction cup that is easier to dislodge from a rest surface than other cupably sized suction cups.

It is another object of the invention to provide feet for a device that incorporates suction cups, the suction cups being easier to dislodge than conventional suction cups of a similar size.

It is yet another object of the invention to provide a suction cup having at least one through opening in a side wall.

Accordingly, there is provided a suction cup having a side wall. The through opening is provided in the side wall.

In some embodiments of the invention, the through opening is located on a part of the side wall that deforms to come into contact with the rest surface.

In other embodiments of the invention, the side wall has a portion that does not come into direct contact with the rest surface and a through opening is formed in that portion of the side wall. The suction cup includes a covering flap or flange that seals the one or more openings when the suction cup is installed on a surface and that uncovers the openings when a vertical force is applied to a portion of the suction cup.

In further embodiments, a suction cup foot is provided having a slot that intersects or interrupts an edge of a side wall.

In other embodiments of the invention, a suction cup foot has an interior ceiling featuring ribs.

In yet further embodiments of the invention, a motorised appliance is supported by suction cup feet, each foot having a ceiling having ribs.

It is a further object of the invention to provide a suction foot for a device incorporating the aforementioned features.

### BRIEF DESCRIPTION OF THE DRAWING FIGURES

In order that the invention be better understood, reference is now made to the following drawing figures in which:

FIG. 1 is a side elevation of a motorised blender base incorporating suction cup type feet.

FIG. 2 is a cross section of the foot depicted in FIG. 1.

FIG. 3 illustrate a suction type foot with through openings in the side wall.

FIG. 4 illustrates a second embodiment of a suction type foot with through openings in the side wall.

FIG. 5 illustrates in schematic cross section, an operational sequence of a suction cup type foot.

FIG. 6 illustrates in schematic cross section, an operational sequence of a suction cup type foot.

FIG. 7 illustrates in schematic cross section, another embodiment of a suction cup type foot with through openings in a side wall.

FIG. 8 illustrates in schematic cross section, a suction type foot with centrally located reciprocating valve element.

FIG. 9 illustrates another embodiment of a suction cup type foot with internal flap.

FIG. 10 illustrates a suction cup type foot with tapered through openings.

FIG. 11 illustrates common schematic cross section, a suction type foot with through openings in a side wall and a tapered side wall.

FIG. 12 is a perspective view of a suction cup foot.

FIG. 13 is an inverted perspective of the foot depicted in FIG. 12.

FIG. 14 is a cross sectional view of the suction cup foot depicted in FIG. 13, in a relaxed orientation.

FIG. 15 is a cross sectional view of the foot depicted in FIG. 14, in a collapsed orientation.

FIG. 16 is an underside plan view of an appliance having suction cup feet of the type shown in FIGS. 14 and 15.

### BEST MODE AND OTHER EMBODIMENTS

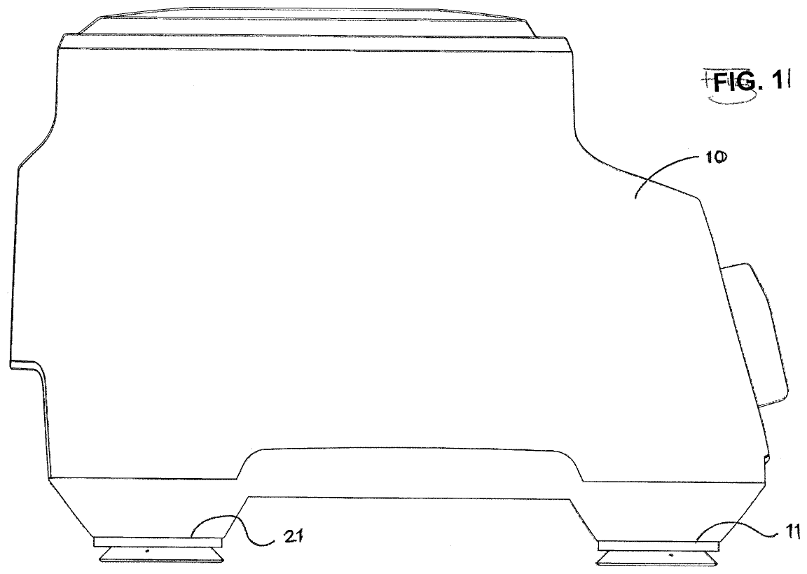

As shown in FIG. 1, a device such as a base for a motorised beverage blender 10 comprises a body that is supported by any number of suction feet 11. In the example of a motorised blender, the base is generally supported by four suction feet 11. It will be appreciated that the invention is not limited by the number of suction feet or the device to which a suction foot is attached.

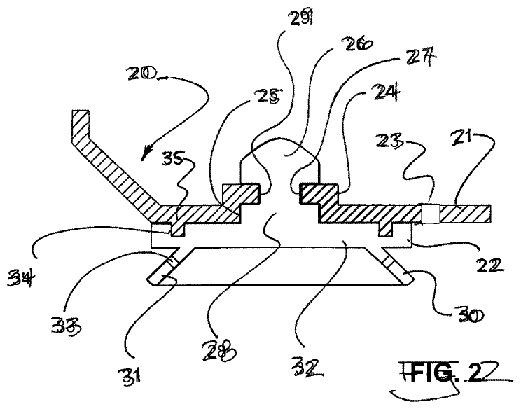

As shown in FIG. 2, a device 20 has a floor 21 that is adapted to retain a suction foot 22. In the example of a beverage blender 10, the point of attachment for the foot 22 comprises a lower most portion of the body. In this way, liquids inadvertently entering the body are able to be discharged through one or more openings 23 in this lower most portion if required. In the example of a thin walled construction 28, the lower surface may be stepped 24 to provide a receiving opening 25 for the hub of suction foot 22. Because the suction foot 22 is an elastomeric polymer, its enlarged head 26 can be passed through an opening 27 in the stepped portion or floor 24. The suction foot 22 has, in this example, a central hub 28 that is received by the stepped proportion 24 and a peripheral groove 29 for receiving the rim of the opening 27 in the stepped portion or floor of the device.

In the example of FIG. 2, the suction foot 22 further comprises a suction cup 30 having a side wall 31 and a ceiling 32. The side wall 31 features one or more through openings 33. In this example, an upper surface of the ceiling 32 and a lower surface of the floor 21 have cooperating or interlocking features such as ribs or posts that inhibit rotation of the foot. In this example, an upper surface of the ceiling has grooves 34 that receive ribs or projections 35 that extend from the lower surface of the floor 21. This feature is particularly important where the suction foot is not round and its rotational orientation relative to a device's body must be preserved.

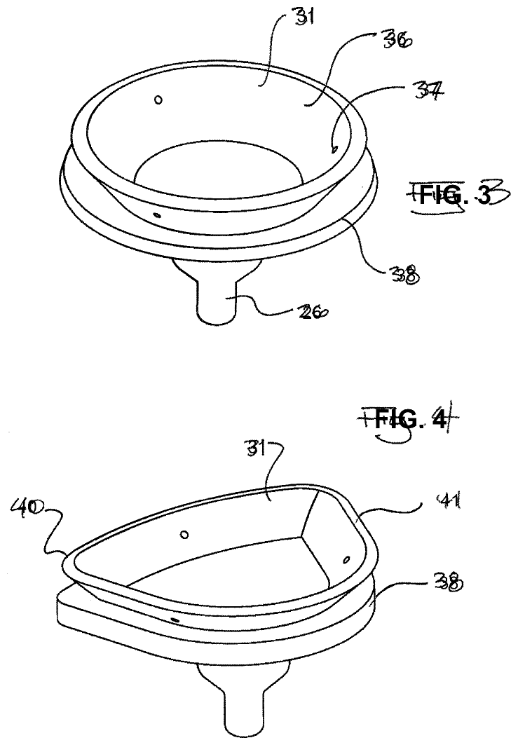

As shown in FIG. 3, a suction cup type foot in an inverted position is seen as having a truncated conical side wall 36 in which are formed one or more through openings 37. A circumferential flange or flap 38 surrounds the entirety of the cup portion 31.

As shown in FIG. 4, neither the cup portion 31 nor the flange that surrounds it 38 are required to be either round or radially symmetric. Feet in accordance with the teachings of the present technology can be manufactured in a wide variety of shapes. In the example of FIG. 4, the foot shape is akin to a “D”. The corners 40 of the lower rim 41 of the cup portion are preferably radiused, not sharp.

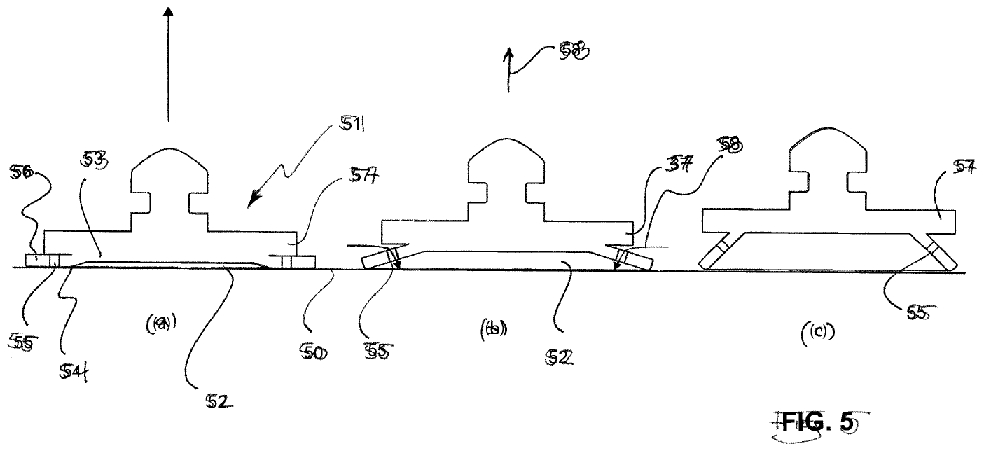

An operational sequence of a suction cup type foot of the kind depicted in FIGS. 1-4 is shown in FIG. 5. As shown in FIG. 5(a), a rest surface 50 supports a suction foot 51 in an adhered orientation. In the adhered orientation, a pocket or compartment 52 under partial vacuum is formed between the cup portion's ceiling 53 and the rest surface 50. The pocket has a maximum horizontal extent 54 that is defined by the pocket 52. Radially outward of this extent of the pocket 54, the interior surface of the cup portion is in flat contact with the rest surface 50. Air can neither enter nor exit the pocket 52 because the through openings 55 in the side wall 56 are not in communication with the pocket 52. The lower part of the opening 55 is occluded by the rest surface 50 and the upper part of the through opening 55 is covered by an under-surface of the flange 57 or flap.

Lifting a device to which the suction foot is attached vertically upward 58 pulls the flange 57 away from the upper portion of the through opening 55. This allows the air pressure within the pocket 52 to equalise owing to the inbound flow of air 58. Once air 58 begins to enter the pocket 52 the partial vacuum is lost and the suction foot will attempt to return to its resting state as shown in FIG. 5(c).

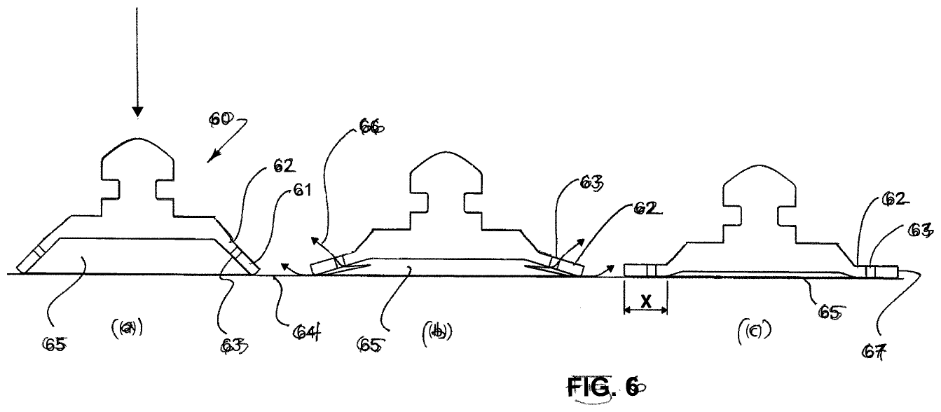

A second embodiment is depicted in FIG. 6. As shown in FIG. 6(a) a foot 60 may have a suction cup portion 61 having side walls of the cup portion that are provided with through openings 63. Because the cup material is elastomeric polymer it will deform as depicted in FIGS. 6(b) and (c). Pressing the foot toward the rest surface 64 reduces the internal volume of the pocket 65 and thereby expels air 66 from the through openings 63. Owing to the shape of the side walls and the elasticity thereof, a circumferential contact margin having a width X is formed around the pocket 65 and the partial vacuum contained in it. In this example, through openings in the side wall 62 are only located within the contact margin, being a distance X from the outermost rim 67 of the cup portion. In this orientation, the one or more through openings 63 are isolated from the pocket 65. The partial vacuum of the pocket 65 will not be interrupted until the suction foot is lifted, as suggested by FIG. 6(b).

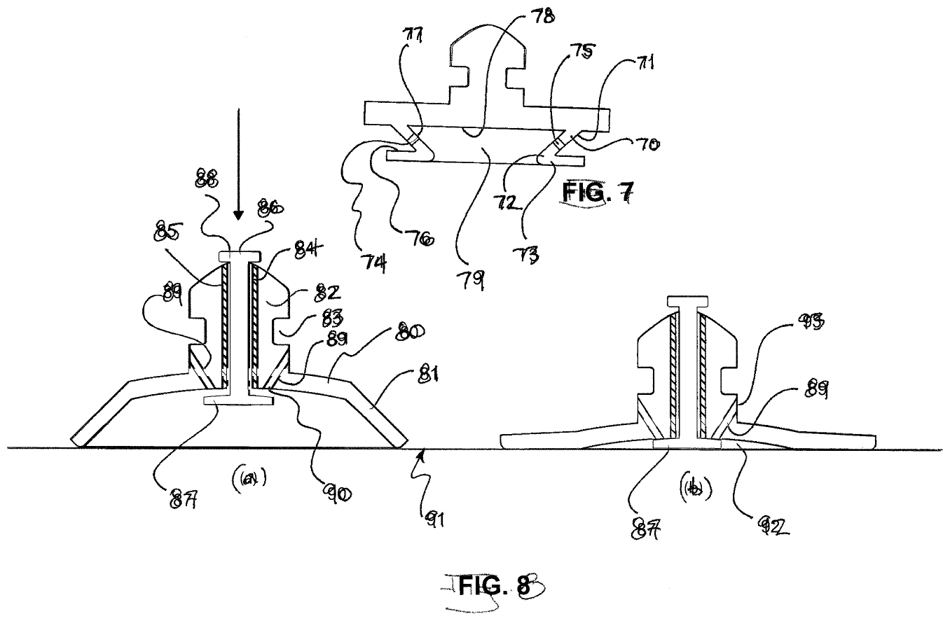

Another embodiment is depicted in FIG. 7. In this example, the side wall 70 of the cup portion has a “Z” shaped resting state corresponding to the depiction in FIG. 7. The side wall 70 comprises a first essentially conical portion that tapers inwardly from an upper part 71 of maximum diameter to a lower part 72 of minimum diameter. The side wall also includes a continuity or rim that extends horizontally 73 from the lowermost part of the tapered side wall portion 71. When pressed down, the side wall will deform so that the lower part 74 of each opening 75 is covered by an upper surface 76 of the horizontal extension or rim 73. This upper surface 76 is an exterior surface of the cup portion. The upper part 77 of the opening 75 becomes covered by the cup's ceiling 78. When both ends 74, 77 of the opening 75 are occluded, no air can enter or escape from the pocket 79. The partial vacuum is relieved when the foot or the device that it is attached to are lifted vertically.

A further embodiment is depicted in FIG. 8(a) and (b). As shown in FIG. 8(a) a suction foot 80 has a cup portion 81 and a central hub 82. The central hub 82 may have features such as a circumferential groove 83 that are used to affix the suction foot to a device. The hub 82 has a central through opening 84 that may be rigidized with a cylindrical insert 85. A freely moving stopper 86 extends through the central opening 84. The stopper 86 has an enlarged valve head 87 at its lower end. An enlarged head 88 at the upper end of the stopper prevents the stopper from falling through the central opening 84. Vent openings or through openings 89 extend from the exterior to a location 90 that can be blocked by the lower enlarged head 87. When pressed down onto the rest surface 91 air is expelled from the pocket 92 and the lower ends of the one or more openings 89 are occluded by the upper part of the enlarged had 87. The upper end opening 93 of the vent openings 89 may be located on the hub or on a side wall of the suction cup portion.

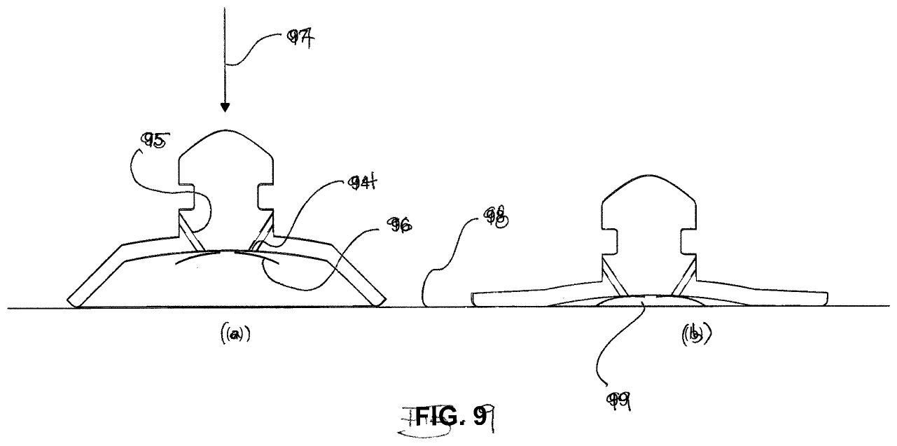

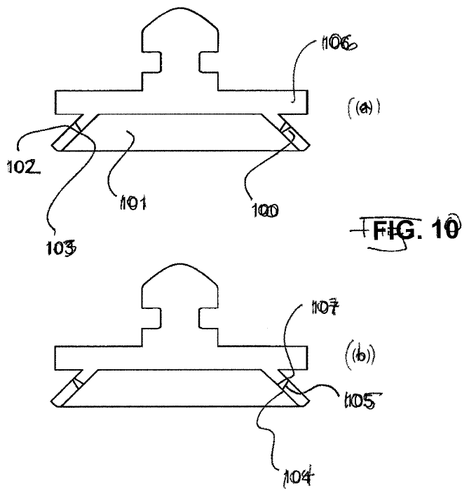

As shown in FIG. 9(a) the lower ends 94 of the one or more vents or through holes 95 may be selectively blocked or unblocked by one or more internal flaps 96. As the suction foot is urged downward 97 toward the rest surface 98 air is able to be expelled from the openings 95. However, at the lower extent of travel, and as shown in FIG. 9(b) the one or more flaps 96 occlude the lower ends 94 of the openings. Thereafter, air can only be reintroduced into the pocket 99 by lifting the foot and thereby unblocking the lower ends 94. In this example, the through holes 95 pass through the hub 95a.

As suggested by FIGS. 10(a) and 10(b) a through opening 100 that cooperates with the interior or pocket 101 of the cup portion may be tapered. The larger diameter 102 may be on the exterior surface of the side wall, thereby locating the smaller diameter 103 of the opening on an interior surface of the cup portion. In the alternative, the larger diameter 104 of a tapered vent opening 105 may be located on the interior surface of the cup portion. Tapering the vent opening can have an impact on the rate of air flow into or out of the cup portion as well as the ease with which a flange or other member 106 can be lifted off of the exterior opening 102, 107.

As shown in FIG. 14 the side wall or side walls 110 of the suction cup portion of a suction foot in may be tapered. Preferably, the wall thickness is greater at the upper part 112 of a side wall and thinner at a lower portion 113 of the side wall. This allows for greater flexibility and stretching in the area of the lower rim 114. Thinning the side wall toward the lower rim 14 makes the surface contact margin X (see FIG. 6(c)) larger.

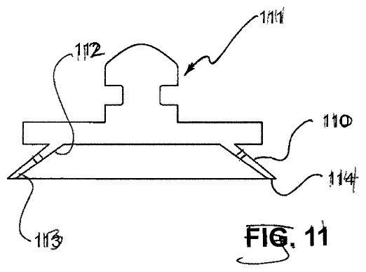

As shown in FIG. 12, a suction cup foot 120 has a side wall 121 in which is formed a notch 122. The notch begins at the lower most rim 123 and preferably extends, perpendicular to the rim, partially but not completely up the side wall 121. In this example the length of the slot 122 is approximately one third to one half the linear extent 124 of the side wall in the area of the notch or slot 122.

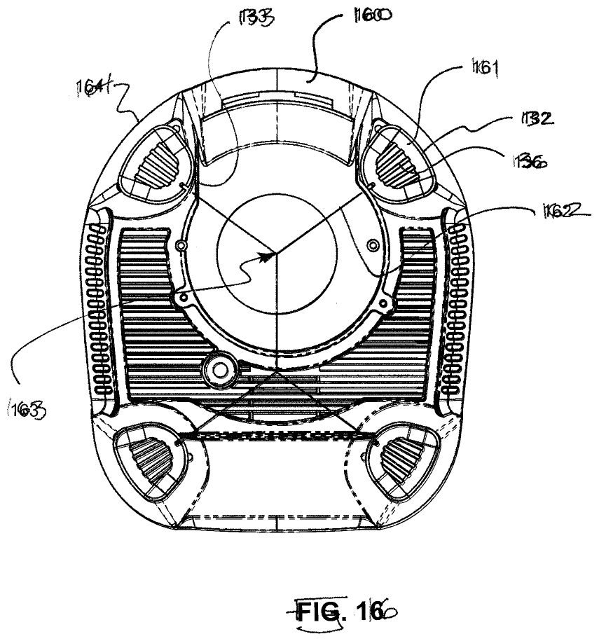

As shown in FIG. 13, a suction cup foot, in accordance with any of the previous teachings, comprises a side wall 130 having an optional notch or slot 131 as disclosed with reference to FIG. 12. Note that with reference to FIG. 16, the suction cup foot has an outward facing edge 132 having a larger radius than the inward facing part of the edge 133. The slot 131 is preferably located directly on or adjacent to a line of symmetry 134 that subdivides the left and right hand sides of the foot. In the example of FIG. 13, the interior of the foot has a ceiling 135 defined by ribs 136. In this example, the ribs are straight and generally aligned with the longitudinal axis of symmetry 134. The ribs may extend across the entirety or only a portion of the ceiling 136.

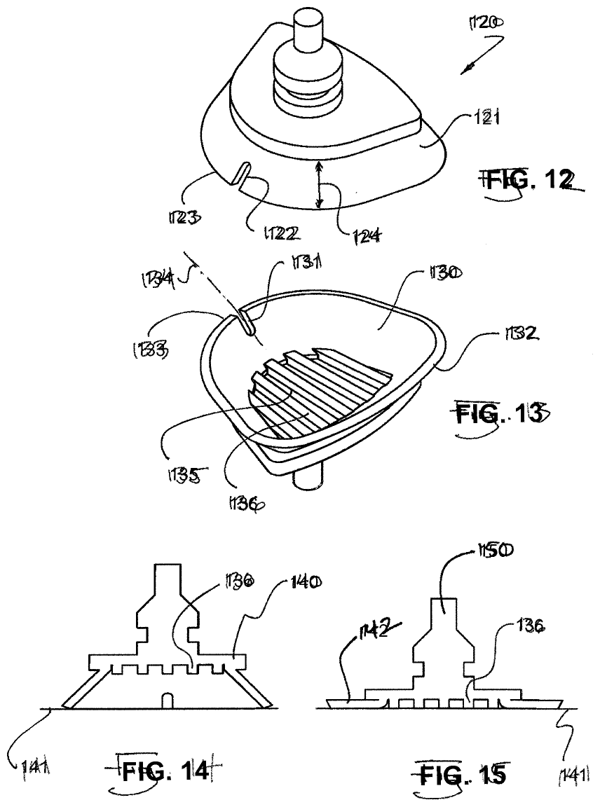

As shown in FIG. 14, when there is little or no load on the suction cup foot 140 the ribs 136 are located above a resting surface 141. When the suction cup foot is loaded or flattened, as shown in FIG. 15, the underside of the ribs 136 is drawn against the resting surface 141. The side wall 142 is collapsed or flattened against the resting surface 141. The ribs create additional friction and resistance to inertia created by aggressive changes in speed of the device supported by the suction cup foot 150.

As shown in FIG. 16, an appliance such as a food processor 160 is supported by four suction cup feet 161 of the type disclosed with reference to FIGS. 12-15. In preferred embodiments, the orientation of the ribs 136 is in exact or in close alignment with a radius 162 that extends outward from a centre of rotation 163, or generally extending away from the centre of the device. Note that the outside edges 132 of each of the suction cup feet 161 conforms in curvature to the exterior 164 of the body of the appliance 160 in the area of the particular foot.

Although the invention has been described with reference to specific examples, it will be appreciated by those skilled in the art that the invention may be embodied in many other forms.

As used herein, unless otherwise specified, the use of the ordinal adjectives “first”, “second”, “third”, etc., to describe a common object, merely indicate that different instances of like objects are being referred to, and are not intended to imply that the objects so described must be in a given sequence, either temporally, spatially, in ranking, or in any other manner.

Reference throughout this specification to “one embodiment” or “an embodiment” or “example” means that a particular feature, structure or characteristic described in connection with the embodiment is included in at least one embodiment of the present invention. Thus, appearances of the phrases “in one embodiment” or “in an example” in various places throughout this specification are not necessarily all referring to the same embodiment or example, but may. Furthermore, the particular features, structures or characteristics may be combined in any suitable manner, as would be apparent to one of ordinary skill in the art from this disclosure, in one or more embodiments.

Similarly it should be appreciated that in the above description of exemplary embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Any claims following the Detailed Description are hereby expressly incorporated into this Detailed Description, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those in the art. For example, in the following claims, any of the claimed embodiments can be used in any combination.

Thus, while there has been described what are believed to be the preferred embodiments of the invention, those skilled in the art will recognize that other and further modifications may be made thereto without departing from the scope of the invention, and it is intended to claim all such changes and modifications as fall within the scope of the invention.

While the present invention has been disclosed with reference to particular details of construction, these should be understood as having been provided by way of example and not as limitations to the scope of the invention.

What is claimed is:

1. A suction foot device, comprising:
a side wall in which is formed a notch.

2. The device of claim 1, wherein:
the foot has a lower most rim; and the notch begins at the lower most rim.

3. The device of claim 2, wherein:
the notch extends perpendicular to the rim.

4. The device of claim 2, wherein:
the notch extends between one third to one half of a linear extent of the side wall.

5. The device of claim 1, wherein:
the foot has an edge with an outward facing part and an inward facing part;
the outward facing part having a larger radius than the inward facing part.

6. The device of claim 1, wherein:
the notch is located along or near a line of symmetry that subdivides a left and right sides of the foot.

7. The device of claim 1, wherein:
the foot has an interior with a ceiling defined by ribs.

8. The device of claim 7, wherein:
the ribs are straight.

9. The device of claim 8, wherein:
the ribs are aligned with a longitudinal axis of symmetry of the foot.

10. The device of claim 7, wherein:
the ribs extend across only a portion of the ceiling.

11. The device of claim 5, wherein:
the foot has an interior with a ceiling defined by ribs.

12. The device of claim 6, wherein:
the foot has an interior with a ceiling defined by ribs.

13. An appliance having a suction foot in accordance with any one of claims 1-12.

14. The appliance of claim 13, wherein:
the appliance is a motorised beverage blender.
